(19) United States
(12) Patent Application Publication
(10) Pub. No.: US 2021/0041398 A1
(43) Pub. Date: Feb. 11, 2021

(54) INFRASTRUCTURE DETECTION AND MONITORING SYSTEM

(71) Applicant: Transportation IP Holdings, LLC, Norwalk, CT (US)

(72) Inventors: Henro Van Wyk, Brisbane (AU); Luciano Antinossi C. da Mata, Belo Horizonte (BR); Felipe Rezende de Carvalho, Belo Horizonte (BR); Adam Franco, Melbourne, FL (US); Adam Hausmann, Melbourne, FL (US); Daniel Rush, Saint Charles, IL (US); Derek Woo, Melbourne, FL (US); Robert Palanti, West Melbourne, FL (US); Nelyo Oliveira, Melbourne, FL (US); Carlos Paulino, Melbourne, FL (US); Marshall Tetterton, West Melbourne, FL (US); Maurice Hutchins, Mims, FL (US); Lee Covert, Port St. John, FL (US); Joseph Nazareth, Melbourne, FL (US)

(21) Appl. No.: 16/943,526

(22) Filed: Jul. 30, 2020

Related U.S. Application Data
(60) Provisional application No. 62/882,914, filed on Aug. 5, 2019.
(60) Provisional application No. 62/899,640, filed on Sep. 12, 2019.

(51) Int. Cl. G01N 29/04; G01N 29/14; G01W 1/10

(52) U.S. Cl. CPC G01N 29/041; G01N 29/14; G01N 2291/263; G01N 2291/0289; G01W 1/10

(57) ABSTRACT

An infrastructure detection and monitoring system includes a remote data storage system that receives and communicates sensor data and signals regarding infrastructure health. The remote data storage system processes and/or stores at least a first sensor data portion and generates advisory signals based on the first sensor data portion. The advisory signals are communicated to a receiver device responsive to the sensor data indicating that the health of the infrastructure indicates imminent failure. Additionally or alternatively, the receiver device can generate one or more control signals responsive to the advisory signals or responsive to the sensor data indicating that the heath of the infrastructure indicates imminent failure of the infrastructure.

### CROSS-REFERENCE TO RELATED APPLICATIONS

This application claims priority to U.S. Provisional Application No. 62/882,914, which was filed 5-Aug. 2019 and to U.S. Provisional Application No. 62/899,640, which was filed on 12 Sep. 2019. The entire disclosures of these applications are incorporated herein by reference.

### BACKGROUND

### Technical Field

Embodiments of the subject matter disclosed herein relate to a system and method for monitoring infrastructure and determining a status of the infrastructure.

### Discussion Of Art

Performance monitoring may be useful in assuring a safe design and operation of certain infrastructure systems, such as dams. One type of dam is a tailings storage facility. Monitoring is an input for informing timely implementation of Emergency Responses Plans if an upset condition occurs. A structural failure of a tailings storage facility may cause a review into the adequacy of current monitoring systems and the effectiveness of trigger action response plans and emergency response plans, which rely on monitoring data. Advancement in performance monitoring may be needed within the mining industry to rapidly collect and display, high confidence monitoring data.

Performance monitoring systems may use a variety of instrumentation in combination with remote sensing technologies to measure a response of the tailings storage facility (e.g. tailings containment dams, embankments, basins, reclaim pools, etc.) during construction of raises and operation of the facility. Instrumentation and remote sensing technologies used in performance monitoring of a tailings storage facility may include, but is not be limited to, the use of the following sensor and sensor systems: piezometers, tensiometers, inclinometers, shape acceleration arrays, surveying pins, satellite-based interferometric synthetic-aperture radar (InSar), terrestrial-based radar, drone or satellite-collected optic and photogrammetric surveys, bathymetric survey, laser scanning, thermal imaging, time-domain reflectometry, flowmeters, weirs, water level gauges, accelerometers, weather stations, optical sensors, and field visual inspection. The output from monitoring systems may require evaluation to verify conformance of performance of the tailings storage facility to the design intent. The design intent may be characterized by a clearly defined and conservative threshold.

The process of timely evaluation of monitoring data of the tailings storage facility may be faced with a number of challenges, such as the ability to rapidly collect, manage, and display data from various monitoring instruments and remote sensing technologies in a single, georeferenced software/hardware package. The data from monitoring systems can be collected in different formats. For example, a piezometer may collect pore pressure records at a single location on a daily basis, while an InSar scan may generate displacement three-dimensional point cloud data at a single point in time. Integrating spatial data with different formats, from point measurements (e.g. piezometers) to surface measurements/pixels at varying timescales within a single, georeferenced package may present a challenge that is currently unmet. The ability to integrate monitor data provides a way for assessing performance of the tailings storage facility, the ability for remote viewing and assessment of data using secure connection and controlled access, the management of data quality, and integration of response plans.

With regard to performance assessment, remote sensing technologies generate point-cloud data that may contain errors due to atmospheric conditions, changes in reflectance, abrupt changes in topography, etc. As the resolution of remote sensing technologies improves, very large spatial data sets are generated. These larger data sets may be difficult to manage and to identify potential data errors. Land-based instrumentation may be subject to errors from aging equipment, poor installation, calibration errors, vandalism, etc. Identification of potential instrumentation errors may require the evaluation of trend data as well as comparisons to other nearby instrumentation. Instrumentation arrays in tailings storage facilities may be large, resulting in time consuming data checks that prevent timely detection of potential performance issues of the tailings storage facilities.

With regard to the integration of monitoring data with trigger action response plans and emergency response plans, this currently is managed using a variety of separate software packages or spreadsheets. This ad hoc approach may result in errors in data interpretation and timely communication of performance issues at the tailings storage facility. Some georeferenced software/hardware packages may integrate data collected from different monitoring instruments and remote sensing technologies.

Additionally, vehicles carry a variety of different categories of cargo through a wide variety of terrain. Travel through some areas and/or over some terrain can be hazardous. For example, it may be too dangerous for a manned vehicle to travel through some areas due to natural disasters. Additionally, these areas may not allow manned vehicles to legally travel through the areas due to the risk posed to humans onboard the vehicles.

This inability to travel with manned vehicles through some areas can significantly restrict operations of a transportation network and/or other facilities. For example, a town, mine, etc., that is accessed through such a dangerous area may be in accessible until the hazard has been eliminated. This can have a significantly negative impact on residents of the town, operation of the mine, etc.

### BRIEF DESCRIPTION

In one embodiment, an infrastructure detection and monitoring system includes a remote data storage system configured to receive and communicate sensor data and signals regarding health of an infrastructure. The remote data storage system is configured to process, store, or both process and store at least a first data portion of the sensor data and to generate one or more advisory signals based at least in part on the first data portion. The infrastructure detection and monitoring system also includes at least one sensor associated with the infrastructure and configured to generate the sensor data that is communicated to the remote data storage system, and a receiver device configured to receive the one or more advisory signals. The remote data storage system can be configured to communicate the one or more advisory signals to the receiver device responsive to the sensor data indicating that the health of the infrastructure indicates imminent failure of the infrastructure. Additionally or alternatively, the receiver device can be configured to generate one or more control signals responsive to the one or more advisory signals or responsive to the sensor data indicating that the heath of the infrastructure indicates imminent failure of the infrastructure. Imminent failure of the infrastructure may be identified, detected, or determined when the sensor data exceeds a threshold or is trending to exceeding a threshold within a designated period of time (e.g., twelve hours, three days, etc.), where the threshold is associated with a likelihood (e.g., 80%) of failure of the infrastructure. Alternatively, imminent failure of the infrastructure may be identified, detected, or determined when the sensor data falls below a threshold or is trending to falling below a threshold within a designated period of time, where the threshold is associated with a likelihood of failure of the infrastructure. While the infrastructure may not actually fail, the threshold can be set so as to provide a period of time for people, equipment, and/or vehicles to safely evacuate the hazardous area associated with the infrastructure before failure occurs.

In one embodiment, a method (e.g., for monitoring an infrastructure) includes receiving sensor data regarding health of the infrastructure from at least one sensor associated with the infrastructure, generating one or more advisory signals based on the sensor data that is received, and communicating the one or more advisory signals to a receiver device responsive to the sensor data indicating that the health of the infrastructure indicates imminent failure of the infrastructure.

In one embodiment, an infrastructure detection and monitoring system includes a remote data storage system configured to receive and communicate sensor data and signals regarding health of a dam. The remote data storage system is configured to process, store, or both process and store at least a first data portion of the sensor data and to generate one or more advisory signals based at least in part on the first data portion. A fiber optic cable is associated with the dam and is configured to generate the sensor data that is communicated to the remote data storage system. A receiver device is configured to receive the one or more advisory signals. The remote data storage system can be configured to communicate the one or more advisory signals to the receiver device responsive to the sensor data indicating that the health of the dam indicates upcoming failure of the dam. Additionally or alternatively, the receiver device can be configured to generate one or more control signals responsive to the one or more advisory signals or responsive to the sensor data indicating that the heath of the dam indicates upcoming failure of the dam.

### BRIEF DESCRIPTION OF THE DRAWINGS

The subject matter described herein includes descriptions of non-limiting embodiments, with reference to the attached drawings, wherein below:

FIG. 1 is a schematic view depicting an embodiment of an infrastructure detection and monitoring system;

FIG. 2 is a schematic view depicting an embodiment of the infrastructure detection and monitoring system deployed at a dam;

FIG. 3 illustrates a flowchart of one example of a method for monitoring an infrastructure;

FIG. 4 illustrates one example of a vehicle control system; and

FIG. 5 illustrates a flowchart of one embodiment of a method for controlling movement of an unmanned vehicle system in a defined zone.

### DETAILED DESCRIPTION

Embodiments of the subject matter disclosed herein relate to an infrastructure monitoring system that includes one or more of a remote data storage system, a sensor system, and/or a receiver device. The remote data storage system can receive and communicate data and signals, and can process, store, or both process and store at least a first data portion and to generate one or more cloud advisory signals based at least in part on the first data portion. The cloud advisory signals can be signals communicated from, to, between, and/or among cloud computing devices. The sensor can generate sensor data to be communicated to the remote data storage system. The receiver device can receive the advisory signals sent from the remote data storage system. Cloud computing devices can be computers (e.g., devices having one or more processors that perform operations) that are available on-demand for processing information (e.g., sensor data), in some embodiments without direct active management by a user. The cloud computing devices can be located over multiple locations that are distant from each other (e.g., not in the same building, zip code, state, or the like). One or more of the cloud computing devices can be close to a sensor and/or receiver device. For example, the cloud computing device that is closer to a sensor or receiver device than one or more (or all) other cloud computing devices can be referred to as an edge computer device or edge system. The cloud computing devices can share processing resources and/or memory to achieve coherence and economies of scale of the computing devices.

In one embodiment, the monitoring system includes an edge system disposed proximate to at least one sensor and configured to process at least a portion of sensor data prior to the sensor data being communicated to a remote data storage system. The edge system can generate an edge advisory signal and communicate the edge advisory signal to the receiver device, the remote data storage system, or both the remote data storage system and the receiver device.

The remote data storage system can receive and communicate sensor data and signals regarding the health of infrastructure. The remote data storage system can process, store, or both process and store at least a first data portion of the sensor data and generate one or more advisory signals based at least in part on the first data portion. This processing can involve examining historical and current sensor data to determine whether the sensor data meets one or more designated criteria associated with a hazardous condition. The designated criteria can be trends in the data (upward or downward in values over time), whether the sensor data is exceeding a threshold associated with a healthy infrastructure, falling below the threshold associated with a healthy infrastructure, and/or is outside of a range of acceptable values associated with a healthy infrastructure, or the like. The hazardous condition can be a poor health state of infrastructure, increased likelihood of failure of the infrastructure, or the like. The sensor(s) can be associated with the infrastructure (e.g., by being positioned at or within the infrastructure) and generates the sensor data that is communicated to the remote data storage system.

In one embodiment, the remote data storage system can include many cloud computing devices disposed in different geographic locations (e.g., different zip codes, different towns, different cities, or the like). Different cloud computing devices can be disposed closer to different infrastructures, different equipment at the different infrastructures, or a different vehicles at different infrastructures. The cloud computing devices can receive sensor data from a variety of different sensors disposed at the different geographic locations. The cloud computing devices can analyze the sensor data provided by these sensors and report portions of the sensor data (or results of the analysis of the sensor data) to other cloud computing devices. The cloud computing devices that are edge devices disposed closer to some infrastructures, equipment, or vehicles can receive some, but may not receive all, of the sensor data or results of analysis of the sensor data. For example, the cloud computing devices may send the sensor data or analysis results of the sensor data acquired at or near (e.g., within a ten kilometer radius) the infrastructure, equipment, or vehicle. The edge devices can therefore receive the sensor data that is relevant to the infrastructures to which the edge devices are closer than other cloud computing devices. The edge devices can include the received sensor data in additional analysis or processing of historical sensor data to determine if the data indicates that the infrastructure is trending toward failure. For example, the same weather conditions (e.g., four to six centimeters of predicted rainfall) may be communicated to the edge devices that are within the geographic region where the rainfall is predicted to occur. A first edge device can be closer to a first dam that was more recently inspected (and passed inspection), is newer, or the like, relative to a second dam. A second edge device can be closer to a second dam that was not inspected, inspected longer ago, or failed inspection, that is older, or the like, relative to the first dam. This same weather data can be examined by the first edge device and determined to not indicate that the first dam is trending toward failure. But, this weather data can be examined by the second edge device and determined to indicate that the second dam is trending toward failure. One or more advisory signals may then be generated by the second edge device and communicated to equipment and/or vehicles at the infrastructure. Optionally, in one embodiment, the edge device that generates the advisory signal can be the receiver device described herein.

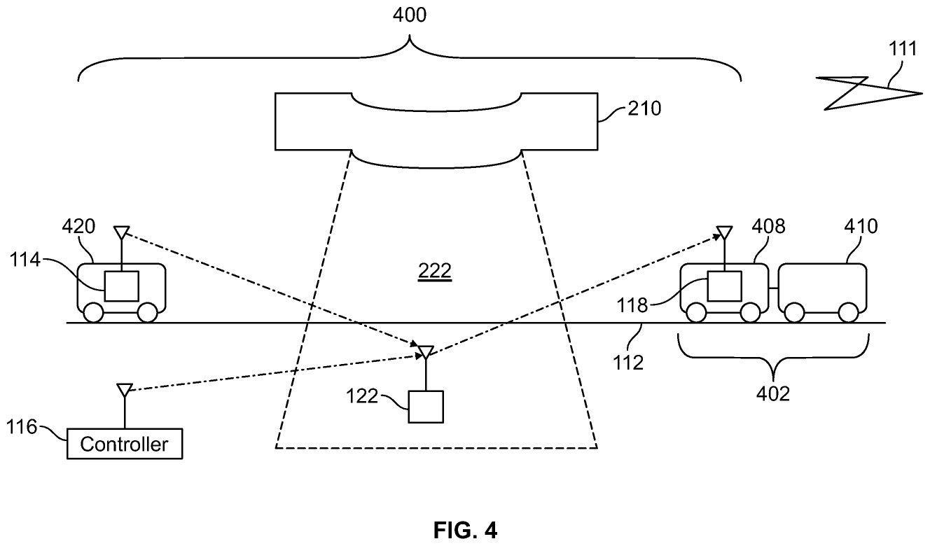

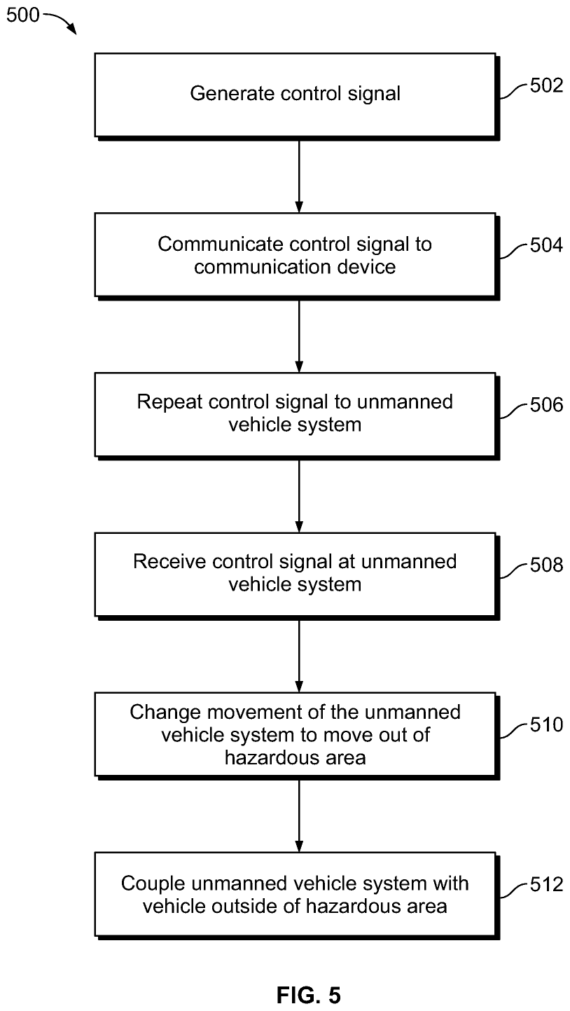

The receiver device can receive the cloud advisory signals responsive to the sensor data indicating that the health of the infrastructure indicates meets one or more designated criteria (e.g., the sensor data indicates that an area is hazardous due to flooding, potential flooding, failure of an infrastructure, etc.). This receiver device can operate to warn operators, equipment, or the like, of the impending failure of the infrastructure. This can allow for the operators to manually move and/or the equipment to automatically move away from a hazardous area of the infrastructure, to change operation of the equipment to prevent or reduce the likelihood of infrastructure failure, or the like. For example, the vehicle control system described in connection with FIGS. 4 and 5 can be used to remotely control movement of a vehicle or vehicle system to automatically move away from a hazardous area of the infrastructure. The receiver device can be a wearable device, a stationary device, a warning and alarm system, a back-office computer, a laptop computer, a smart phone, or the like.

The detection system also can include an edge system disposed proximate to the sensor(s) that processes at least a second portion of the sensor data prior to the sensor data being communicated to the remote data storage system. This edge system can intercept the sensor data or receive a separate copy of the sensor data sent from the sensor(s) to the remote data storage system. The edge system can examine the sensor data similar or in a manner different from the remote data storage system to determine whether to warn the receiver device(s) of impending failure of the infrastructure. For example, the edge system can look for the same or different trends in the sensor data as the remote data storage system, compare the sensor data to the same or different thresholds or ranges as the remote data storage system, or the like. The edge system can generate an edge advisory signal and communicate the edge advisory signal to the receiver device, the remote data storage system, or both the remote data storage system and the receiver device. The edge advisory signal, the cloud advisory signal, or both the edge advisory signal and the cloud advisory signals can communicate a status of the infrastructure to the receiver device. For example, this status may indicate impending failure (e.g., failure within the hour, within the day, or within the week), or may provide other status information, such as a current health of the infrastructure (even when no failure is imminent).

The status that is reported can indicate the type of infrastructure and/or location of the infrastructure (e.g., whether the infrastructure is a dam, a mine, a road, a bridge, a wellbore, an abutment, a retaining wall, a bunding, rail road track, a water distribution system, a pipeline system, a fuel distribution system, a snow bank or permafrost sheet, a port, a dock system, or the like, as well as coordinates or a postal address of the infrastructure), a current health of the infrastructure (e.g., the infrastructure is operating within a defined capacity or output, the sensor readings are within or outside of an acceptable range, etc.), a predicted health of the infrastructure, a weather condition, an operating condition (e.g., water is flowing out of the dam at a measured rate), or a forecasted condition for weather or operation.

The edge advisory signal can be generated by equipment at or near the location of the infrastructure and the edge advisory signal can be an alert of infrastructure failure or a prediction of infrastructure failure. The receiver device can be a smart phone or an area alert system that warns people in a determined hazard zone of a status of the infrastructure. For example, responsive to the sensor data indicating that a dam is about to fail, the signal can be sent to receiver device(s) within a defined area downstream or below the dam to warn of the upcoming failure of the dam. The receiver device can communicate with relief equipment that is configured to reduce a risk of the infrastructure failure. For example, the receiver device can communicate with a motor coupled with a valve that can operate to open or close the valve (to direct water held back by the dam to another location) and thereby reduce the likelihood of or prevent the failure of the dam.

Optionally, the receiver device can communicate with a vehicle or other equipment that is within the hazard zone of the infrastructure or that is moving to or toward the hazard zone. The vehicle or the other equipment can respond to receipt of the edge advisory system by changing an operating mode of the vehicle or the second equipment. For example, the vehicle can automatically change movement to move out of the hazard zone. As another example, the receiver device can communicate with the vehicle control system described herein in connection with FIGS. 4 and 5 to remotely control movement of the vehicle system out of the hazard zone.

In aspects, sensor data may be assessed for determining an actual infrastructure failure, or a predicted or imminent failure where there is eventually an actual failure. In other aspects, the sensor data may be assessed for determining a possible or likely failure (imminent or otherwise)—with an advisory signal generated/communicated accordingly—but where (for example due to changing circumstances) there is not eventually an actual failure. Thus, unless specified otherwise herein in regards to specific embodiments, indications of imminent failure include assessing sensor data, relative to designated criteria, to determine not only actual failures and forthcoming actual failures, but predicted or possible failures (of either determinate or indeterminate timing but where the data indicates the possibility of an eventual failure), etc., whether or not a failure actually occurs.

As noted, in embodiments, the advisory signal can be an alert of infrastructure failure, imminent infrastructure failure, or a prediction of infrastructure failure. In other embodiments, sensor data of the infrastructure may be assessed (e.g., by the edge device, remote storage device, or receiver device) relative to other information that may be indicative of the possibility of infrastructure failure if one or more events or eventualities occur in the future, such that it may be desirable to take precautionary measures relative to the infrastructure to maintain a safety margin. In other embodiments, a portion of the sensor data relating to a first part of the infrastructure may be assessed relative to another portion of the sensor data relating to a second part of the infrastructure, which may be indicative of the possibility of infrastructure failure of the first part if one or more events or eventualities occur in relation to the second part, again, such that it may be desirable to take precautionary measures relative to the first part of the infrastructure to maintain a safety margin. For example, in the case of a tailings dam or other dam hydrologically connected to a watershed, the sensor data may include first sensor data associated with the structure of the dam, and it may include second sensor data associated with the structure of one or more upstream dams, dykes, levees, etc., sensor data of upstream waterflow, sensor data of water amounts, sensor data of rainfall, sensor data of seismic activity, and so on. Here, the system could be configured to assess both the first sensor data and the second sensor data, and to issue advisory signals if the second sensor data meets designated criteria and even if the first sensor is completely nominal. In the provided example, the first sensor data could indicate that the conditions of the dam are completely normal (and in-and-of-itself not indicative of a possible failure), but the second data could indicate failure of an upstream feature, upstream rain or water levels above a designated threshold (e.g., potentially too much rain/water for the dam to handle), mud slides or other remote activity that could affect the dam in time, etc. Based on such data, the system could communicate advisory signals for possible precautionary actions at the dam, even though conditions immediately at the dam are nominal, for a safety margin in case actual conditions at the dam deteriorate.

In other embodiments, the system is configured for generating and communicating advisory signals if the sensor data meets one or more designated criteria, relating to either imminent infrastructure failure or, more generally, indicative of conditions or possible (e.g., predicted/future) conditions where it may be desirable to take a remedial action or other control action to keep operations relative to the infrastructure within designated safety margins.

The sensor(s) can include one or more of a piezometer, a tensiometer, an inclinometer, a shape acceleration array, a surveying pin, a Satellite-based Interferometric Synthetic-Aperture Radar (InSar) device, a terrestrial-based radar device, a drone or satellite-collected optic and photogrammetric surveyor, a bathymetric surveyor, a laser scanner, a thermal imager, a Time-Domain Reflectometer (TDR), a flowmeter, a weir with flowmeter, a water level gauge, a seismometer, an array of seismometers, a fiber optic system, or an accelerometer. The sensor(s) can generate the sensor data via at least one of a weather station or by field visual inspection. The sensor(s) may be fixed in position, or may be mobile. For example, one or more of the sensors can be disposed in a drone that flies around the infrastructure to collect sensor data, can be disposed in a robotic device that moves around the infrastructure on surfaces to collect sensor data, or can be carried on a user as a wearable device or a smartphone.

The sensor can provide the sensor data to include a date stamp indicating what day the data was acquired, a time stamp indicating what time the data was acquired, a date and time stamp indicating what day and time the data was acquired, a location indicating where the data was acquired, an acoustic measurement indicating sounds as the sensor data, a temperature measurement indicating a temperature as the sensor data, a strain measurement indicating mechanical strain on one or more components of the infrastructure, or a vibration measurement indicating accelerations or vibrations measured in or around the infrastructure. Optionally, the sensor data can include weather data including weather at the infrastructure and weather adjacent to the infrastructure, predictive weather data, seismographic readings, tidal information, vehicle data (e.g., vehicle location, vehicle type, and/or vehicle loading), photographic data (e.g., including time lapse photos and/or videos), thermographic data, spatial measurements, environmental data (e.g., air humidity, air temperature, snowpack levels, water height, water flow rates, ground water levels, ground saturation levels, etc.), infrastructure height (e.g., relative to ground or to sea level), infrastructure age and condition, and/or foliage type and amount.

Using the sensor data, the remote data storage system can determine whether the sensor data indicates failure of the infrastructure, whether the sensor data indicates a trend toward a future failure of the infrastructure, whether a combination of the sensor data from a plurality of different sensors indicates that the infrastructure is failing, whether a natural event occurred that has increased a risk of failure of the infrastructure and when the natural event occurred, whether there is a combination of the sensor data that indicates the risk of failure has increased, which personnel is to receive an advisory signal of an elevated risk in advance of a failure, whether there is a war or political risk that would change a determination of the risk of failure, or determine a location of a vehicle traversing the infrastructure associated with the at least one sensor and whether the vehicle is loaded or unloaded based on weight.

In one embodiment, the infrastructure is a tailings dam and the sensor includes a fiber optic cable that is disposed at least partially within the tailings dam. The remote data storage system can receive the sensor data from the fiber optic cable and build a base line of sensor readings from the sensor data. In response to a change in the sensor readings relative to the base line that exceeds a determined threshold value relative to an earlier sensor reading, the remote data storage system can create a cloud advisory signal to send to the receiver device.

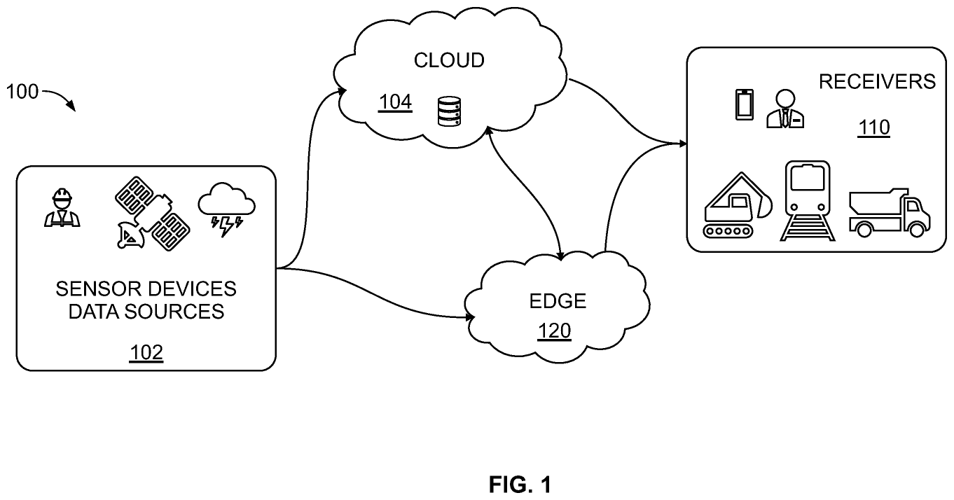

With reference to FIG. 1, a schematic of an infrastructure detection and monitoring system 100 according to an embodiment of the inventive subject matter is provided. The system includes one or more sensor devices 102 that may communicate via a cloud-based information system 104 with one or more receivers 110. The cloud-based information system can represent the remote data storage system described herein, and can include cloud computer devices that are connected with each other via one or more networks (e.g., processors communicating with each other via wired and/or wireless networks), as described above. In one embodiment, an edge computing device 120 is disposed on or in equipment or vehicles proximate to the infrastructure being monitored by the system. As described above, the edge computing device may be at least one of the cloud computing devices that is closer to the equipment or vehicles than one or more (or all) other cloud computing devices. The edge computing device can represent one or more of the receivers. Optionally, the edge computing device can include or be coupled with one or more of the sensor devices, and also can operate as a sensor device. The information system and/or edge computing device can include or represent hardware circuitry that includes and/or is connected with one or more processors (e.g., microprocessors, integrated circuits, field programmable gate arrays, etc.) that perform operations described herein. Edge computing may not have access to information from other locations (for comparison purposes) or historical or archival information about the infrastructure site. But the edge computer device may be able to determine quickly whether a health status of the infrastructure has fallen below a determined threshold and/or may be in risk of failure or collapse.

The systems described herein can monitor and process sensor data to determine the health of the infrastructure. This health can be the current health of the infrastructure so that the sensor data can be used to monitor the infrastructure health in real-time (e.g., as the health or sensor data changes). Optionally, the health that is determined can be a predicted health of the infrastructure. For example, the systems described herein can examine a current or last known health of the infrastructure, as well as predicted weather conditions (e.g., predicted rainfall into the area that will increase the amount of water held back by a dam), predicted or scheduled usage of the infrastructure, and the like. The health can be predicted based on this information. For example, a dam that needs repair or scheduled repair has been delayed) and where a significant amount of rainfall is predicted can be determined to have a poor health state (e.g., will fail).

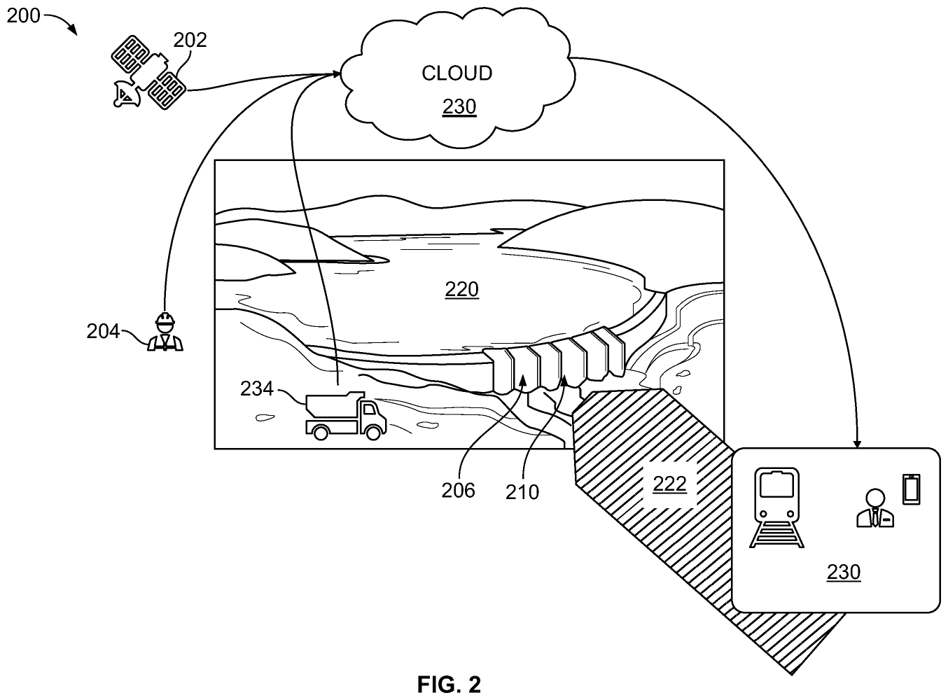

With reference to FIG. 2, another example of an infrastructure detection and monitoring system 200 is provided. The detection and monitoring system 200 shown in FIG. 2 can represent the detection and monitoring system 100 shown in FIG. 1. The detection and monitoring system 200 can include a sensor system formed from sensor devices such as satellite measurement sensors 202, hand-held sensors 204, and fiber optic cable 206 that is embedded in a tailings dam 210. The satellite measurement sensors can include sensor devices that measure characteristics from or using an airborne position, such as from satellites, aircraft (manned or unmanned), or the like. These types of sensors can obtain optical data (e.g., images and/or video), thermal data (thermal or heat maps), location data (e.g., global positioning system coordinates), or the like. In one example, a satellite measurement sensor may be a device that communicates with airborne devices to make one or more measurements, such as a global positioning system receiver. The dam holds back a reservoir of water 220 from a hazard zone or area 222 that is downstream of the dam. At least one receiver device 230 is disposed in the hazard zone and is in communication with a remote data storage system 232. The remote data storage system 232 can represent the cloud based information system shown in FIG. 1. A construction or mining vehicle 234 is operating near the dam outside of the hazard zone.

During operation, the satellite measurement sensor may monitor the dam and report movement data of the dam, fill amounts of the reservoir, weather patterns and the like, to the remote data storage system. The hand-held sensors may check for water saturation or leakage from the dam, soil density, and the like, and report that information (e.g., via wireless communication) to the remote data storage system. The mining vehicle may include sensors (e.g., global positioning system receivers) that relay the operating location of the vehicle to the cloud-based system. The fiber optic cable can sense movement or other vibrations in a structure (e.g., the dam) and/or ground. In the event that the fiber optic cable senses movement of the dam at a rate of change or at magnitude greater than a determined threshold level, the remote data storage system may determine that risk level within the hazard zone has risen above a determined risk level and may respond by generating and issuing an advisory signal to the receiving devices (and operators of the receiving devices) located within the hazard zone. If the prediction by the remote data storage system is not of failure of the dam (for example), then the remote data storage system may generate an advisory signal and communicate the advisory signal to monitors outside of the hazard zone so that determinations may be undertaken to dispatch repair crews and the like to the infrastructure so as to lower the risk level and prevent a failure of the dam.

A suitable sensor system can include one or more of piezometer, tensiometers, inclinometer, shape acceleration array, surveying pin, satellite-based interferometric synthetic-aperture radar (InSar), terrestrial-based radar, drone or satellite-collected optic and photogrammetric surveyor, bathymetric surveyor, laser scanner, thermal imager, time-domain reflectometer (TDR), flowmeter, weir with flowmeter, water level gauge, and/or accelerometers. The sensor system may generate sensor data via at least one of a weather station or by field visual inspection. Other suitable sensor systems may include a seismometer or an array of seismometers. Yet other suitable sensor systems may include a fiber optic system. The fiber optic system may include a high fidelity or a low fidelity fiber optic system selected based on application specific parameters.

The sensor system may be disposed directly in infrastructure. As used herein, infrastructure may be one or more a dam, a mine, a road, a bridge, a wellbore, an abutment, a retaining wall, a bunding, railroad track, a water distribution system, a pipeline system, a fuel distribution system, a snowbank or permafrost sheet, and a port or dock system. Other suitable infrastructure may include a levee or dike. In one embodiment, at least one sensor system is disposed in a drone or robotic device or is carried on a user as a wearable device or a smartphone. If drone or vehicle mounted, the sensor system may be mobile and may generate sensor data in different locations. As such, drone data may include location data (including elevation), as well as the drone or vehicle, as part of the sensor system, may be used to transfer data from other sensors to the remote data storage system.

The sensor system may provide sensor data comprising one or more of a date/time stamp, location, acoustic, temperature, strain and vibration. This can be useful in situations where the sensor system includes a fiber optic cable.

The sensor system may provide sensor data comprising one or more of weather data comprising weather at the infrastructure and weather adjacent to the infrastructure (e.g., uphill or upriver); predictive weather data; seismographic readings; tidal information; digital audio data, vehicle data comprising vehicle location, vehicle type, and vehicle loading; photographic data including time lapse photos and videos; thermographic data; spatial measurements, environmental data comprising air humidity and air temperature, snow pack levels, precipitation, water height and flow rates, ground water levels, and ground saturation levels; infrastructure height (relative to ground or to sea level); infrastructure age and condition; and foliage type and amount.

With regard to the remote data storage system, the remote data storage system may receive sensor system data and determine whether the sensor data indicates a failure of infrastructure associated with the sensor system. The remote data storage system can examine the sensor data to determine whether the sensor data includes or indicates a trend toward a future failure of infrastructure associated with the sensor system. The remote data storage system can examine combinations of sensor data from a plurality of sensor systems to determine whether the combinations of sensor data indicate that the infrastructure is failing, or may fail. The remote data storage system can examine the sensor data to determine whether a natural event occurred (earthquake, tornado, lightning strike, fire, hurricane, volcanic eruption) that has increased a risk of failure of the infrastructure, and, if so, when the failure is likely to occur. The remote data storage system may determine whether there is a combination of sensor data that indicates the increased risk—such as a weather event saturating the infrastructure with water followed by a delated increase in pressure on a dam that is now saturated rather than dry (that is, does the preceding sensor data change the threshold or risk for subsequent sensor data readings).

The remote data storage system may determine who needs to get an advisory signal of an elevated risk in advance of a failure, and alerting those personnel (by function, by location); determine if there is a war/political risk that would change the determination of the threat level; and determine location of a vehicle traversing infrastructure associated with the sensor system (and whether the vehicle is loaded, unloaded based on weight). For example, responsive to determining an increasing or elevated risk of failure, the remote data storage system can communicate an advisory signal to those personnel having receivers and that are within a threshold distance of the infrastructure. Optionally, the remote data storage system can communicate the advisory signal to those personnel having expertise or training that is associated with the infrastructure, the sensor data indicating the elevated risk of failure, etc.

When using an edge device (that is, a computer/processor disposed with equipment proximate to the field use), the edge device can receive the sensor data and examine the sensor data to determine whether there is an increased risk of failure. The edge device can then communicate an advisory signal to one or more receiver device to notify personnel of the risk of failure.

A receiver device may receive the advisory signal from the remote data storage system and/or the edge device. Such a receiver device may be a wearable device, a stationary device, a warning and alarm system, a back office computer, a laptop computer, tablet computer, or a smart phone. The receiver device can provide visual, audible, and/or tactile notifications of the advisory signal to notify personnel associated with the device of the elevated risk of failure.

The edge advisory signal, the cloud advisory signal, or both the edge and cloud advisory signals can communicate a status of the infrastructure to the receiver device. This status can indicate one or more of the infrastructure type (e.g., a dam, a ramp, a road, etc.) and location, a current infrastructure health component, a predictive infrastructure health component, weather conditions, operating conditions, and forecast conditions for weather or operations. The health components can be quantified values or scores of the health of the infrastructure, whether the health value or score be current based on sensor data or predicted based on trends or patterns in the sensor data. The edge advisory signal may be generated by equipment at or near the location of the infrastructure and the edge advisory signal is an alert of infrastructure failure or a prediction of infrastructure failure.

The edge advisory signal may be generated by equipment at or near the location of the infrastructure and the edge advisory signal can be or can include an alert of infrastructure failure or a prediction of infrastructure failure or compromised infrastructure that could lead to an infrastructure failure. The receiver device can communicate with relief equipment that is configured to reduce a risk of infrastructure failure (pressure relief or diverter valve), and the relief equipment responds by reducing the infrastructure failure risk (e.g., lowers water level). For example, responsive to receipt of an alert that a dam is at increased risk of failure, a valve can be activated to change states to direct water out from behind the dam (e.g., into a lower waterway or other reservoir). This can reduce the backpressure behind the dam and may reduce or eliminate the likelihood of failure of the dam.

The edge advisory signal may be generated by equipment at or near the location of the infrastructure and the edge advisory signal is an alert of infrastructure failure or a prediction of infrastructure failure or compromised infrastructure that could lead to an infrastructure failure, and the receiver device can communicate with a vehicle or equipment or device (e.g. personal wearable) that is within a hazard zone or moving to or towards the hazard zone, and the vehicle or equipment or device is responsive to the edge advisory system by changing its operating mode (such as by leaving the hazard zone) or by providing information to persons within the hazard zone to respond appropriately. For example, responsive to data from sensor devices indicating that a dam has an increased risk of failure, the edge computing device may communicate with receivers to determine which receivers are within a threshold distance (e.g., ten kilometers) of the dam and/or that are within a hazard area below the dam. The edge computing device can send the advisory signal to those receivers, but not other receivers that are outside of this distance and that are not within the hazard area.

Suitable infrastructure may include a tailings dam and the sensor system may be a fiber optic cable that is disposed at least partially within the tailings dam. During operation, the remote data storage system receives sensor data from the fiber optic cable and from this sensor data, the remote data storage system builds a base line of sensor readings. In response to a sudden change in the sensor readings relative to the base line and/or a gradual change in the sensor readings that exceeds a determined threshold value relative to an earlier sensor reading, the remote data storage system can create a cloud advisory signal to send to receivers (e.g., that are near the dam).

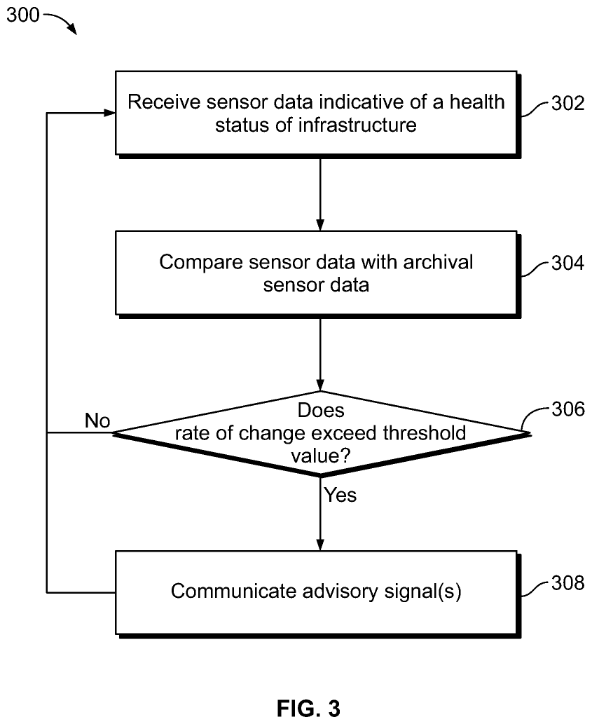

FIG. 3 illustrates a flowchart of one example of a method 300 for monitoring an infrastructure. The method 300 can represent one or more operations of the detection and monitoring system described herein. At 302, sensor data indicative of a health status of an infrastructure is received. This sensor data can be broadcast, transmitted, or otherwise sent from the sensor devices to one or more edge computing devices. The sensor devices can send the sensor data on a continuous basis, on a repeated (periodic and/or irregular) basis, on an on-demand basis, or the like. At 304, the sensor data that is received from the sensors is compared with archival sensor data. The sensor data can be compared with previously obtained sensor data (e.g., archival or historical sensor data) to determine a rate of change for the health status of the determined infrastructure. For example, the health status may have a larger rate of change when the sensor data deviates from the historical sensor data by larger and larger amounts over time, or may have a smaller or no rate of change when the sensor data remains the same over time or has much smaller rates of change.

At 306, a determination is made as to whether the rate of change in the sensor data exceeds a threshold value. For example, the edge computing device can determine whether the rate of change is greater than a threshold rate, whether the most or more recently received sensor data exceeds the historical data by more than a threshold amount, or the like. If the rate of change in the sensor data exceeds the threshold value, then this can indicate that the sensor data meets the one or more designated criteria associated a hazardous condition (e.g., impending or likely failure of the infrastructure). As a result, flow of the method can proceed toward 308. But, if the rate of change in the sensor data does not exceed the threshold value, then this may indicate that the sensor data does not meet the one or more designated criteria associated with the hazardous condition. Flow can then return toward 302 or may terminate.

At 308, an advisory signal is generated and communicated to at least one receiver. For example, responsive to determining that a hazardous condition exists with the infrastructure, advisory signals can be communicated to receivers that are close to the infrastructure or within a hazard zone associated with the infrastructure. These signals can warn operators of components associated with the receivers or can automatically control components to evacuate the area, to implement one or more changes (e.g., open a valve to release pressure behind the dam), to automatically and remotely control movement of a vehicle system, or the like.

The sensor data can be generated via a high-fidelity fiber optic cable, with multiple sensor signals generated per fiber of the cable. If the infrastructure is a tailings dam, and the fiber optic cable is disposed within at least a portion of the tailings dam, the method also may include predicting, based at least in part on the rate of change, a failure of the tailings dam, and the advisory system comprising a prediction of a time-to-fail of the tailings dam, and the receiver responding to the advisory signal by vacating a hazard area below the tailings dam.

In one embodiment, fiber optic cables may detect seismic waves in response to micrometer-scale changes in the length of the cable. As the length changes so does the time it takes a packet of light to traverse to the far end of the cable and back (using a second fiber). In one embodiment, an ultra-stable metrology-grade laser may detect phase changes indicating a minute shift of timing (on the order of femtoseconds). In another embodiment, an event slower than an earthquake, landslide, mine blast, avalanche, or flash flood may be detected by the cable. A slump or slow-moving deformation of infrastructure associated with the sensor system (in this example, a fiber optic cable) may make minute changes in the phase change over a very long period. Collection of data representing the fiber optic signals, establishing a baseline (or rolling baseline), and then comparing subsequent measurements to the baseline may indicate that the infrastructure is moving slowly (rather than as a response to an earthquake). Determined movement thresholds may be set and the system may either indicate a rate of change or generate an alert in response to a threshold level being met.

During operation, in response to a seismic event, the point of the cable first disturbed by a p-wave (essentially a sound wave in rock) from movement of the ground, such as may be caused by earthquakes, landslides, mine blasts, avalanches, flash floods, may be determined by sending packets in both directions in the looped pair of optical fibers; the difference in the arrival times of the first pair of perturbed packets may indicate a the distance along the cable. A second detection on a non-parallel cable may be used to resolve any ambiguity of the resulting solution.

Suitable dams may include one or more of Arch dams, Gravity dams, Arch-gravity dams, Barrages, Embankment dams, Rock-fill dams, Concrete-face rock-fill dams, Earth-fill dams (which may also be referred to as earthen dams, rolled-earth dams or simply earth dams), and Fixed-crest or Low head dams. Other suitable dams may include one or more of a Saddle dam, Weir or an overflow dam, a Check dam, a Dry dam, a Diversionary dam, an Underground dam (either a sub-surface or a sand-storage dam), and a Tailings dam.

A suitable tailings dam may be an earth-fill embankment dam used to store tailings. Tailings may be produced during mining operations after separating the valuable fraction from the uneconomic fraction of an ore. Unlike a water retention dam, a tailings dam may be raised in succession throughout the life of the particular mine. Initially, a base or starter dam is constructed, and as it fills with a mixture of tailings and water, it is raised. Material used to raise the dam can include the tailings (depending on their size) along with dirt.

There are multiple raised tailings dam designs contemplated—the upstream, downstream and centerline. These are named according to the movement of the crest during raising. The specific design may be selected at least in part on upon topography, geology, climate, the type of tailings, and cost. An upstream tailings dam may consist of trapezoidal embankments being constructed on top but toe to crest of another, moving the crest further upstream. This creates a relatively flat downstream side and a jagged upstream side which is supported by tailings slurry in the impoundment. The downstream design refers to the successive raising of the embankment that positions the fill and crest further downstream. A centerlined dam has sequential embankment dams constructed directly on top of another while fill is placed on the downstream side for support and slurry supports the upstream side. Because tailings dams may store material from the mining process, they may have an impervious liner to prevent seepage. Water/slurry levels in the tailings pond may be managed for stability and environmental purposes as well.

During operation, the cloud or edge system may control process management. To this end, the cloud or edge system may provide one or more of trendlines and dashboards, an infrastructure health manager and health indicator, a status chart for one or more global risk key performance indicators (KPI), an early warning advisory signal relating to the infrastructure or abnormal events, changes in conditions: seepage, diversion ditches. The cloud or edge system may provide workflows & event management, such as maintenance management for affected infrastructure, and repair equipment, criticality analysis, strategic management, rounds/inspection management, case management/workflows, and documentation, calibration and certification of the foregoing. The cloud or edge system may provide operation optimization. This may include water balance, storage forecasting, reagent management, minimize effluent discharge, and maximize re-use of process water.

Risk analysis may be performed, in one embodiment, by a cloud-based system using one or more risk models. Suitable risk models may include one or more of Stochastic analytical hierarchy process, Fuzzy comprehensive analysis, Game theory (GT), Probabilistic Neural Network (PNN), Genetic algorithm (GA), and Risk Matrix.

In another embodiment, a fiber optic system may be coupled with other mining equipment and infrastructure. Suitable mining equipment and infrastructure may include a pipeline, a conveyor, a ramp, and a retaining wall. Movements and vibrations sensed by the fiber optic cable may be used to determine and/or predict a health status of the equipment and infrastructure alone or in combination with other sensor data.

In response to an earthquake, for example, the inventive system may monitor the infrastructure for sympathetic movement. For example, a dam may not be destroyed by the earthquake, but may be weakened and the weight of the shifting water in the reservoir may start to push down the dam. Similarly, if the system notes an earthquake (even remote) it may be alert for secondary effects, such as rockslides, tsunamis that are a result of the earthquake. The system may make a health status determination of the infrastructure. That is, a fully healthy dam may survive a tidal wave, but a damaged dam may not—and that determination may be based at least in part on the sensor data provided and the determination of the health status by the remote data storage system. As another example, a dam with a nearly empty reservoir (showing little strain on an embedded fiber optic cable) may survive a heavy rainfall, while a full reservoir may not survive or may require water diversion. That determination may be compounded further by a sub-healthy dam. Accordingly, the remote data storage system may review (from archival data) a history of dam construction, maintenance, age, movement trends, and the like in view of the current sensor data input to predict and model possible outcomes. From that it may generate a risk profile that includes likelihood of risk, severity of damage or failure, and timing of such a risk materializing.

While the infrastructure detection and monitoring system may communicate predictions and warnings (advisories) directly to users and operators that are in a hazard zone, other uses and operators may be members of the communication network. For example, at least one of the receivers can be a back-office system staffed with employees who monitor a plurality of locations and corresponding infrastructure. Further, the infrastructure may be of a mixed nature. For example, a dam may also be a bridge for cars and/or trains. Thus, a warning to current occupants of a hazard area may not be a full complement of warnings. Cars and trains that are headed to or toward a structure that is at risk of collapse may not (yet) be in a hazard zone but may benefit from warnings before the vehicles reach the structure. The cloud-based system then may include or at least communicate with other systems, such as traffic control or warning systems, as the receivers. These other types of receivers can further convey advisory messages to the vehicles. In the case of a train in a railroad setting where the train may be within a hazard zone or heading towards a hazard zone, the cloud-based system may communicate with a vehicle control system that restricts movements of the vehicles as receivers.

In one example of a vehicle control system, a positive control system can be onboard a vehicle and receive signals that indicate which segments of routes that the vehicle is allowed to enter, changed speed limits, the presence of maintenance crews on a route segment, or other situations impacting safe travel of the vehicle. If the positive control system onboard the vehicle receives a signal indicating that the vehicle can enter into a route segment, then the vehicle is allowed to enter into the route segment. But, unless or until the positive control system receives such a signal, the positive control system can prevent the vehicle from being controlled to enter into the route segment. For example, the positive control system can activate brakes of the vehicle, deactivate a propulsion system of the vehicle, or the like. A positive train control system is one example of a positive vehicle control system. In another example of the vehicle control system, a negative control system can be onboard a vehicle and receive signals that indicate which segments of routes that the vehicle is not allowed to enter, changed speed limits, the presence of maintenance crews on a route segment, or other situations impacting safe travel of the vehicle. Unless the negative control system onboard the vehicle receives a signal indicating that the vehicle cannot enter into a route segment, then the vehicle is allowed to enter into the route segment. But, once the negative control system receives such a signal, the negative control system can prevent the vehicle from being controlled to enter into the route segment. For example, the negative control system can activate brakes of the vehicle, deactivate a propulsion system of the vehicle, or the like.

The advisory signals communicated to the receivers can be used to direct the vehicle control systems to allow or prevent vehicles from entering into various route segments, to travel slower than a speed limit of a route, or the like. For example, an advisory signal can be communicated to a positive or negative control system to dictate whether a vehicle should or should not be permitted into the vicinity or hazardous area of an infrastructure that has been identified as imminently failing.

In another example, a receiver can be at or included within a power plant that is located in a hazard zone or have power lines that traverse the hazard zone. An advisory signal can be communicated to this receiver. This advisory signal can instruct the power plant to shut down power or route electricity to other lines in response to a risk level threshold being determined by the cloud (or edge) system.

The hazard zone itself may be static and determined in advance, or may be dynamic and determined in response to situation specific criteria. For example, if a retention pond within a hazard zone of a dam is empty, the downstream risk to the hazard zone may be less or near zero even with a complete collapse of a dam. On the other hand, a full reservoir (or partially full reservoir) may generate a great deal of risk, even if the dam has not yet (and may not) collapsed. A reading from the fiber optic cable may determine the level of strain that corresponds to a fill level of the reservoir or the saturation level of the earthen dam, and a satellite image may determine a fill level, or a flow sensor at a weir may determine the fill level. If some or all of the data is available, it may be used to calibrate the inventive system and may increase the odds of validity and the quality of the predictive analytics.

In one embodiment, a detection and monitoring system includes a remote data storage system configured to receive and communicate data and signals. The remote data storage system also is configured to process and/or store at least a first data portion and to generate one or more cloud advisory signals based at least in part on the first data portion. The detection and monitoring system also includes at least one sensor configured to generate sensor data to be communicated to the remote data storage system and a receiver device configured to receive advisory signals.

Optionally, the detection and monitoring system also can include edge system disposed proximate to the at least one sensor and configured to process at least a portion of sensor data prior to the sensor data being communicated to the remote data storage system. The edge system can be configured to generate an edge advisory signal and communicate such edge advisory signal to the receiver device and/or the remote data storage system.

Optionally, the sensor system includes one or more of piezometer, tensiometers, inclinometer, shape acceleration array, surveying pin, Satellite-based Interferometric Synthetic-Aperture Radar (InSar), terrestrial-based radar, drone or satellite-collected optic and photogrammetric surveyor, bathymetric surveyor, laser scanner, thermal imager, Time-Domain Reflectometer (TDR), flowmeter, weir with flowmeter, water level gauge, and/or accelerometer.

Optionally, the sensor system is configured to generate sensor data via at least one of a weather station and/or by field visual inspection.

Optionally, the sensor system includes a seismometer or an array of seismometers.

Optionally, the sensor system includes a high fidelity or a low fidelity fiber optic system.

Optionally, the sensor system can be disposed in infrastructure comprising at least one of: a dam, a mine, a road, a bridge, a wellbore, an abutment, a retaining wall, a bunding, railroad track, a water distribution system, a pipeline system, a fuel distribution system, a snowbank or permafrost sheet, and/or a port or dock system.

Optionally, the sensor system can be disposed in a drone or robotic device or is carried on a user as a wearable device or a smartphone.

Optionally, the sensor system can be configured to provide sensor data comprising one or more of a date/time stamp, location (or location measurement), acoustic (or acoustic measurement), temperature (or temperature measurement), strain (or strain measurement), and/or vibration (or vibration measurement).

Optionally, the sensor system can be configured to provide sensor data comprising one or more of weather data comprising weather at the infrastructure and weather adjacent to the infrastructure (e.g., uphill or upriver); predictive weather data; seismographic readings; tidal information; vehicle data comprising vehicle location, vehicle type, and vehicle loading; photographic data including time lapse photos and videos; thermographic data; spatial measurements, environmental data comprising air humidity and air temperature, snow pack levels, water height and flow rates, ground water levels, and ground saturation levels; infrastructure height (relative to ground or to sea level); infrastructure age and condition; and/or foliage type and amount.

Optionally, the remote data storage system can be configured to receive sensor system data and determine one or more of the following: is the sensor data indicative of a failure of infrastructure associated with the sensor system?; is the sensor data indicating a trend towards a future failure of infrastructure associated with the sensor system?; is the combination of sensor data from a plurality of sensor systems indicating that the infrastructure is failing, or may fail?; has a natural event occurred (earthquake, hurricane, volcanic eruption) that has increased a risk of failure of the infrastructure, and if so when?; is there a combination of sensor data that, in combination, indicates the increased risk—such as a weather event saturating the infrastructure with water followed by a delated increase in pressure on a dam that is now saturated rather than dry (that is, does the preceding sensor data change the threshold or risk for subsequent sensor data readings)?; who needs to get an advisory signal of an elevated risk in advance of a failure, and alerting them (by function, by location)?; is there is a war/political risk that would change the determination of the threat level?; and/or what is the location of a vehicle traversing infrastructure associated with the sensor system (and whether the vehicle is loaded, unloaded based on weight)?

Optionally, the receiver device can be a wearable device, a stationary device, a warning and alarm system, a back-office computer, a laptop computer, or a smart phone.

Optionally, the edge advisory signal, the cloud advisory signal, or both the edge and cloud advisory signals can communicate (to the receiver device) a status of the infrastructure, and the status indicates one or more of the infrastructure type (e.g., a dam, a ramp, a road) and location, a current infrastructure health component, a predictive infrastructure health component, weather conditions, operating conditions, and/or forecast conditions for weather or operations.

Optionally, the edge advisory signal can be generated by equipment at or near the location of the infrastructure and the edge advisory signal is an alert of infrastructure failure or a prediction of imminent infrastructure failure, and the receiver device can be one of a smart phone or an area alert system that warns people in a determined hazard zone of the status of the infrastructure.

Optionally, the edge advisory signal can be generated by equipment at or near the location of the infrastructure and the edge advisory signal can be an alert of infrastructure failure or a prediction of imminent infrastructure failure, and the receiver device can communicate with relief equipment that is configured to reduce a risk of infrastructure failure (pressure relief or diverter valve), and the relief equipment responds by reducing the infrastructure failure risk (lowers water level, e.g.).

Optionally, the edge advisory signal can be generated by equipment at or near the location of the infrastructure and the edge advisory signal is an alert of infrastructure failure or a prediction of imminent infrastructure failure, and the receiver device can communicate with a vehicle or equipment that is within a hazard zone or moving to or towards the hazard zone, and the vehicle or equipment can respond to the edge advisory system by changing an operating mode of the vehicle or equipment (such as by leaving the hazard zone).

Optionally, the infrastructure can be a tailings dam and the sensor system can include a fiber optic cable that is disposed at least partially within the tailings dam. The remote data storage system can receive sensor data from the fiber optic cable and build a base line of sensor readings from this data. The remote data storage system can create a cloud advisory signal to send to determined receiver devices in response to either a sudden change in the sensor readings relative to the base line or a gradual change in the sensor readings that exceeds a determined threshold value relative to an earlier sensor reading.

In one embodiment, a method includes receiving sensor data indicative of a health status of determined infrastructure, comparing received sensor data with archival sensor data to determine a rate of change for the health status of the determined infrastructure, responding to a rate of change determination that is greater than a determined threshold value by generating an advisory signal, and communicating the advisory signal to at least one receiver.

Optionally, the method also can include generating the sensor data via a high-fidelity fiber optic cable, to include multiple sensor signals per fiber.

Optionally, the infrastructure can be a tailings dam, and the fiber optic cable can be disposed within at least a portion of the tailings dam. The method also can include predicting, based at least in part on the rate of change, a failure of the trailing dam. The advisory system can include a prediction of a time-to-fail of the tailings dam. The receiver can respond to the advisory signal by vacating a hazard area below the tailings dam.

FIG. 4 illustrates one example of a vehicle control system 400. The vehicle control system operates a vehicle system 402 through the hazardous zone 222 (also referred to herein as a defined area). The defined zone may include a hazard area that is hazardous to people, to equipment, or to cargo. By hazardous, it is meant that some aspect of the environmental conditions within the defined zone differ from the conditions outside of the zone, and at least one of those conditions inside the zone may be injurious, deleterious, or undesirable to some object or aspect of the vehicle, as described above in connection with the infrastructure detection and monitoring system. In one embodiment, the hazardous area represents a spatial zone through which no person is allowed to be located or travel through. For example, the hazardous area can be a floodplain of the dam of levee 210 that is at risk of failing. Alternatively, the hazardous area can have or be associated with another type of hazard, as described herein. The operation may be autonomous, remote control, or another operation that differs from the operation of the vehicle system outside of the hazard area. In the exemplary embodiment, the vehicle system is an unmanned vehicle system (i.e., unmanned when controlled through the defined zone).

The vehicle system represents one or more vehicles 408, 410 that are capable of self-propulsion along one or more routes 112 through the defined zone. One or more of the vehicles can be a receiver 110 shown in FIG. 1. The vehicles in the vehicle system can include at least one propulsion-generating vehicle 408 and optionally at least one non-propulsion-generating vehicle 410. Alternatively, the vehicle system may not include any non-propulsion-generating vehicle. The propulsion-generating vehicle can be a vehicle capable of generating tractive effort, propulsion, thrust, or the like for propelling the propulsion-generating vehicle along the route(s). For example, the propulsion-generating vehicle can be a land-based vehicle, such as a locomotive traveling along one or more rails or tracks, an automobile or truck traveling along one or more roads, a mining vehicle traveling along one or more paths, or another land-based vehicle. Other suitable propulsion-generating vehicles can be a non-land-based vehicle, such as a marine vessel traveling along one or more water routes or shipping lanes, an aircraft flying along one or more airborne routes, or the like.

The non-propulsion-generating vehicle, if present, can be a land, air, or water-based vehicle that is not capable of generating self-propulsion. Suitable non-propulsion-generating vehicles can be a rail car, a trailer that can couple with an automobile or truck, a barge, or the like. The propulsion-generating vehicle and/or the non-propulsion-generating vehicle can carry cargo. In one embodiment, the cargo does not include human passengers, but may include minerals, food, livestock, manufactured products, etc. Alternatively, the cargo may include passengers that do not control operation or movement of the vehicle system.

The propulsion-generating vehicle in the unmanned vehicle system does not include a human operator onboard the vehicle system in one embodiment. For example, the propulsion-generating vehicle may be automatically and/or remotely controlled to move along the routes by receiving control signals from a remotely located controller 114 and/or 116 of the control system. The controller 114 can be a controller located onboard another propulsion-generating vehicle 420. Alternatively, the controller 116 can be a controller that is not located onboard the other propulsion-generating vehicle. The other propulsion-generating vehicle can be the same type or category of vehicle as the vehicle 108 or may be another vehicle capable of self-propulsion. Optionally, the controller 114 and/or 116 can be part of the infrastructure detection and monitoring system, such as components of the information system 104 and/or the remote data storage system 232.

The propulsion-generating vehicle may have an onboard control unit 118 that receives control signals from the remotely located controller. This control unit can represent one or more of the receivers 110 described above. These control signals can dictate operational settings that control how the vehicle system is to move along the routes into, through, and/or out of the defined zone. For example, the control signals can direct which throttle settings or positions are to be used, which brake settings are to be used, moving speeds, accelerations, or the like, at one or more different times, locations, and/or distances along the routes. In one embodiment, the region around the vehicle may change from non-hazardous to hazardous. Accordingly, the vehicle may operate to leave the defined zone without having (knowingly) entered the defined zone. For example, the condition that caused the defined zone to become hazardous may move or cease to exist while the vehicle is moving toward, within, or out of the defined zone.

The controllers and control unit can each represent hardware circuitry that includes and/or is connected with one or more processors that operate to perform the functions described herein in connection with the respective controller or control unit. The processors can include one or more microprocessors, field programmable gate arrays, integrated circuits, or the like. The controllers and control unit can include or be connected with communication hardware, such as transceiving circuitry (e.g., antennas, modems, etc.) for wirelessly communicating the control signals between or among each other. Suitable sensors may be used either onboard the vehicle, or wayside of the route within the defined zone, or outside of the defined zone and in each case communicate directly or indirectly with the control unit. A location device may communicate with the control unit. Suitable location devices may include global positioning signal (GPS) devices, inertia and gyroscopic devices, laser range finders, beacons, time-of-flight devices, RADAR, LIDAR, and the like. The sensor package and the location device may be selected with reference to application specific parameters and requirements.

In one embodiment, the onboard and/or remotely located controllers can send the control signals to the control unit so that the unmanned vehicle system moves (according to and/or using the operational settings dictated by the control signals) along the one or more routes without any person being onboard the unmanned vehicle system. This can allow for the unmanned vehicle system and/or the cargo carried by the unmanned vehicle system to travel through and exit the defined zone without risking the safety of a human operator that otherwise would need to be onboard to control the vehicle system. For example, the unmanned vehicle system may be loaded with cargo (e.g., from a mine). Due to a natural disaster or other event causing a prohibition on human travel through the defined zone, the cargo may not otherwise be able to be transported out of or through the defined zone. The controller can send the control signals to the unmanned vehicle system to cause the unmanned vehicle system to automatically or autonomously move through and/or out of the defined zone, thereby bringing the cargo out of the defined zone.

The unmanned vehicle system can be directed (by the control signals) to move out of the defined zone to a location of the other propulsion-generating vehicle. For example, the controller(s) can direct the unmanned vehicle system to move, without an operator being located onboard the unmanned vehicle system, through and/or out of the defined zone. In one example, the unmanned vehicle system may be moved to the other propulsion-generating vehicle that is located outside of the defined zone. This other propulsion-generating vehicle may have one or more human operators onboard that control operation (e.g., movement) of the other propulsion-generating vehicle. The unmanned vehicle system can couple with the other propulsion-generating vehicle outside of the defined area so that the unmanned vehicle system and the other propulsion-generating vehicle form a manned vehicle system. This manned vehicle system has the one or more operators onboard that can control operation of the manned vehicle system to move to one or more additional locations. In doing so, the cargo carried by the unmanned vehicle system can be rescued from, or otherwise brought out of, the defined zone to join with the other propulsion-generating vehicle and taken to a destination location without risking the safety of any living being traveling through the defined zone. Optionally, the unmanned vehicle system may be autonomously and/or remotely controlled to move out of the defined zone, where an operator (e.g., the same operator that was onboard the vehicle system before entering the defined zone or a different operator) boards the vehicle system and begins controlling the vehicle system outside of the defined zone.

In one embodiment, the unmanned vehicle system may not be configured to be remotely controlled by control signals sent from the controller(s). For example, the control unit onboard the unmanned vehicle system may be configured for operating according to control signals received only from a controller onboard a vehicle that is mechanically coupled (directly or indirectly) with the vehicle in which the control unit is disposed. This can occur when the propulsion-generating vehicle(s) in the unmanned vehicle system are configured or set up for distributed power operation, but when none of the propulsion-generating vehicles are configured for or set up as a lead vehicle that controls operation of other vehicles. For example, all the propulsion-generating vehicles in the unmanned vehicle system may be configured or set up as trail or remote vehicles (that are controlled by a lead vehicle). The trail propulsion-generating vehicle(s) in the unmanned vehicle system can be controlled to move through and out of the hazardous area as trail or remote vehicles in a distributed power mode or arrangement, with the controller acting as the lead vehicle in the distributed power mode or arrangement (even though the controller is not onboard a vehicle that is mechanically coupled with the unmanned vehicle system). In this way, the control system operates in a way to mimic, imitate, or emulate operation of a vehicle system operating in a distributed power configuration, even though the vehicle system is separated into two (or more) parts and at least one part (e.g., the other propulsion-generating vehicle that is outside of the defined area) does not move while the unmanned vehicle system moves.

The controller(s) may directly communicate the control signals to the control unit. For example, the control signals may be wirelessly communicated from the controller to the control unit without the control signals being repeated by one or more other devices. This direct communication causes the controller(s) to operate as a communication device or devices, as the controller(s) are both originating the control signals and the last device to send the control signals to the control unit.

Alternatively, the control unit onboard the unmanned vehicle system may be too far from the controller to allow for direct communication of the control signals from the controller to the control unit. As a result, the controller(s) may not operate as a communication device. Instead, an external communication device 122 may repeat or otherwise forward the control signals from the controller(s) to the control unit. The communication device can represent transceiving circuitry that wirelessly communicates signals, such as one or more antennas, modems, or the like. The communication device can receive the control signal(s) from the controller and broadcast or transmit the control signal(s) to the control unit. In this way, the communication device may operate as a repeater of the control signals. The communication device operating as a repeater can spoof the control signals such that the control unit onboard the unmanned vehicle system treats the control signals as though the control signals were sent from a lead vehicle in a distributed power arrangement that includes the unmanned vehicle system.

The communication device may be a land-based device located in the hazardous area. For example, the communication device can be a wayside device located along or near the routes in the hazardous area. Alternatively, the communication device may be outside the hazardous area but be able to communicate with the unmanned vehicle system. In another embodiment, the communication device may be airborne. For example, the communication device may be onboard a manned or unmanned aerial vehicle 111, such as a plane, a drone, a blimp, a balloon, another vehicle, and the like. An aerial vehicle can move to a location over the hazardous area to allow for communication between the controller(s) and the control unit. This can allow for the communication device to be positioned in a location that cannot be reached by the vehicle that is outside the hazardous area (and to which the unmanned vehicle system travels). For example, the aerial vehicle may fly over or hover over the defined area. In another example, the aerial vehicle may track and follow the unmanned vehicle system to remain inside an envelope that allows for communication with both the unmanned vehicle and the controller (or a repeater). As another example, the aerial vehicle may transport and leave the communication device in a location allowing for communication with the controller(s) and the control unit. For example, the aerial vehicle can place the communication device at a high elevation (e.g., on a mountain, near or at the top of a tree, near or at the top of a tower, etc.).

While the defined area is described above as being a flood plain, an area under a flood watch, or an area of increased risk of a flood, alternatively, the defined area can have another risk or hazard. For example, the defined area can be an area of predicted or forecasted adverse weather conditions (e.g., tornadic activity, a hurricane, a tropical storm, a tsunami, high winds, etc.). As another example, the defined area can be an area contaminated by unsafe levels of radiation, an area experiencing fire or dense smoke (e.g., a forest fire), an area where a chemical spill occurred, an area where a gas leak occurred, and the like. The defined area can be an area having dangerous terrain. For example, the routes in the defined area may include bridges that are unsafe for human beings to travel over in vehicles, may be at elevated risks of rockslides, flood zones with uncertain infrastructure integrity, explosive mines (land or water), or the like. Alternatively, the defined zone may be part of a route where it is otherwise undesired to have persons onboard a vehicle system, e.g., because the vehicle system is required to move very slowly through the zone, because the operator of the vehicle system has to temporarily perform duties offboard the vehicle system, etc.

In one embodiment, the vehicle system may carry one or more auxiliary devices that perform functions during travel through or within the defined zone. For example, the vehicle system may include sensors that detect characteristics within the defined zone. These sensors may be grouped into sensor packages, and the sensors can obtain information about the defined zone in locations where a human operator cannot, should not, or is not permitted to travel. The vehicle system can be remotely controlled to move through the defined zone while the sensors collect information on the conditions within the defined zone. The sensor-collected information can be provided to the controllers or another device to determine the conditions within the defined zone. Examples of sensors include cameras, thermometers, wind gauges, radiation sensors, chemical analyte sensors, or the like. Some of these sensor packages provide data that allows for navigation and/or operation of the vehicle while in the defined zone.

While the above description focuses on remotely controlling the vehicle system to travel out of the defined zone or area, alternatively, the control system can operate to control the vehicle system to enter the defined area from outside of the defined area. For example, the controller can remotely control the vehicle system to enter the defined area to obtain sensor information (described above), to deliver products or substances in the defined area (e.g., to deliver water to a forest fire, to apply a chemical to neutralize a chemical spill, etc.), or the like.

FIG. 5 illustrates a flowchart of one embodiment of a method 500 for controlling movement of a vehicle system in a defined zone. The method 500 can represent operations performed by the control system shown in FIG. 4 (in one embodiment). Optionally, the method 500 can represent operations performed in response to the infrastructure detection and monitoring system determining that sensor data meets the one or more designated criteria (associated with a hazardous condition of infrastructure). At 502, a control signal is generated at the controller. This control signal can dictate an operational setting to control movement of the vehicle system. The control signal can be generated by the controller onboard the vehicle that is outside of the defined zone and/or by the controller that is off-board the vehicle. At 504, the control signal is communicated to a communication device. For example, the control signal may be sent from the controller to the communication device that is closer to the vehicle system (than the controller) and/or that is within the defined zone. At 506, the control signal is repeated from the communication device to the control unit of the vehicle system. For example, the communication device may repeat the control signal without altering the control signal so that the control unit of the vehicle system treats the control signal as being received by a lead propulsion-generating vehicle that is coupled with the vehicle system. Alternatively, the control signal can be sent directly from the controller to the control unit without being repeated at one (or more) communication devices. At 508, the control unit of the vehicle system receives the control signal. At 510, movement of the vehicle system changes based on the control signal that is received. For example, the vehicle system may begin moving, change speed, change direction, or the like. The movement of the vehicle system can cause the vehicle system to travel to the vehicle that is outside of the defined zone. At 512, the vehicle system couples with the manned vehicle that is outside of the defined zone. The combined vehicle and vehicle system can now be a manned vehicle system with one or more operators onboard the manned vehicle. The combined vehicle system can then travel to one or more additional locations.

In one embodiment, a method includes determining that a vehicle moving in a manned operative state is approaching a defined zone. The vehicle is controlled based at least in part on manual input received from an operator onboard the vehicle while in the manned operative state. The method also includes, responsive to the vehicle approaching the defined zone and the operator disembarking from the vehicle, switching the vehicle from the manned operative state to an unmanned operative state and controlling the movement of the vehicle in the unmanned operative state of the vehicle during travel of the vehicle inside the defined zone. The vehicle is autonomously controlled or remotely controlled while in the unmanned operative state.

Optionally, the method also includes, responsive to the vehicle exiting the defined zone, switching the vehicle from the unmanned operative state to the manned operative state. The vehicle is controlled based on manual input received from the operator or another operator that boarded the vehicle subsequent to the vehicle exiting the defined zone.

Optionally, the method also includes receiving sensor data from one or more sensors. The sensor data may be indicative of one or more characteristics inside the defined zone. The movement of the vehicle may be controlled in the unmanned operative state using the sensor data.

Optionally, the method also includes monitoring a location of the vehicle moving in the unmanned operative state within the defined zone using the sensor data.

Optionally, the method also includes determining a presence of a hazard to continued travel of the vehicle moving in the unmanned operative state within the defined zone using the sensor data.

Optionally, the method also includes automatically changing the movement of the vehicle moving in the unmanned operative state within the defined zone based on the presence of the hazard that is determined.

Optionally, controlling the movement of the vehicle in the unmanned operative state of the vehicle during travel of the vehicle inside the defined zone includes sending a control signal from a controller outside of the defined zone to a repeater device located in the defined zone and repeating the control signal from the repeater device to the vehicle.

Optionally, the method also includes positioning the repeater device within the defined zone using an unmanned aerial vehicle.

Optionally, the method also includes moving the repeater device with the unmanned aerial vehicle to track the movement of the vehicle in the defined zone.

Optionally, the repeater device is one of several repeater devices in different locations in the defined zone. The method also can include sending the control signal to different ones of the repeater devices as the vehicle moves through the defined zone based on the locations of the repeater devices.

In one embodiment, a system includes one or more processors configured to determine that a vehicle moving in a manned operative state is approaching a defined zone. The vehicle is controlled based on manual input received from an operator onboard the vehicle while in the manned operative state. The one or more processors are configured to switch the vehicle from the manned operative state to an unmanned operative state responsive to the vehicle approaching the defined zone and the operator disembarking from the vehicle. The one or more processors also are configured to control the movement of the vehicle in the manned operative state of the vehicle during travel of the vehicle inside the defined zone. The one or more processors autonomously or remotely controlling the vehicle while the vehicle is in the unmanned operative state.

Optionally, the one or more processors are configured to, responsive to the vehicle exiting the defined zone, switch the vehicle from the unmanned operative state to the manned operative state and to control the vehicle based on manual input received from the operator or another operator that boarded the vehicle subsequent to the vehicle exiting the defined zone.

Optionally, the one or more processors are configured to receive sensor data from one or more sensors. The sensor data may be indicative of one or more characteristics inside the defined zone. The one or more processors may be configured to control the movement of the vehicle in the unmanned operative state using the sensor data.

Optionally, the one or more processors are configured to monitor a location of the vehicle moving in the unmanned operative state within the defined zone using the sensor data.

Optionally, the one or more processors are configured to determine a presence of a hazard to continued travel of the vehicle moving in the unmanned operative state within the defined zone using the sensor data.

Optionally, the one or more processors are configured to automatically change the movement of the vehicle moving in the unmanned operative state within the defined zone based on the presence of the hazard that is determined.

In one embodiment, a method includes determining that a manually controlled vehicle is not permitted to travel in a manned operative state within a defined zone, switching the vehicle from the manned operative state to an unmanned operative state, and autonomously or remotely controlling movement of the vehicle in during travel of the vehicle inside the defined zone.

Optionally, the method also includes, responsive to the vehicle exiting the defined zone, switching the vehicle from the unmanned operative state to the manned operative state. The vehicle may be controlled based on manual input received from the operator or another operator that boarded the vehicle subsequent to the vehicle exiting the defined zone.

Optionally, controlling the movement of the vehicle in the unmanned operative state of the vehicle during travel of the vehicle inside the defined zone includes sending a control signal from a controller outside of the defined zone to a repeater device located in the defined zone and repeating the control signal from the repeater device to the vehicle.

Optionally, the method also includes positioning the repeater device within the defined zone using an unmanned aerial vehicle.

In another embodiment, a method includes, with a controller onboard a first vehicle system located outside a defined zone, remotely or autonomously controlling a second vehicle system for travel through the defined zone. While the second vehicle system is traveling through the defined zone, the second vehicle system is unmanned and not physically coupled to the first vehicle system; also, during this time the first vehicle system may be stationary.

In another embodiment, the method further includes transmitting control signals from the first vehicle system to a repeater, for the repeater to repeat the control signals to the second vehicle system. The repeater is located offboard both the first vehicle system and the second vehicle system. The repeater may be affixed to a land surface, or carried by an unmanned or other aerial vehicle, or the like.

In another embodiment, prior to being controlled by the first vehicle system for travel through the defined zone, the method includes switching the second vehicle system from operating as (or including) a distributed power lead vehicle to operating as a distributed power remote vehicle.

In one embodiment, an infrastructure detection and monitoring system includes a remote data storage system configured to receive and communicate sensor data and signals regarding health of an infrastructure. The remote data storage system is configured to process, store, or both process and store at least a first data portion of the sensor data and to generate one or more advisory signals based at least in part on the first data portion. The infrastructure detection and monitoring system also includes at least one sensor associated with the infrastructure and configured to generate the sensor data that is communicated to the remote data storage system, and a receiver device configured to receive the one or more advisory signals. The remote data storage system can be configured to communicate the one or more advisory signals to the receiver device responsive to the sensor data indicating that the health of the infrastructure indicates imminent failure of the infrastructure. Additionally or alternatively, the receiver device can be configured to generate one or more control signals responsive to the one or more advisory signals or responsive to the sensor data indicating that the heath of the infrastructure indicates imminent failure of the infrastructure.

Optionally, the infrastructure detection and monitoring system can include an edge system disposed proximate to the at least one sensor and be configured to process at least a second portion of the sensor data prior to the sensor data being communicated to the remote data storage system. The edge system can include a cloud computing device that is closer to one or more of equipment or a vehicle at the infrastructure than one or more other cloud computing devices. The edge system can be configured to generate at least one of the advisory signals and communicate the at least one of the advisory signals to the receiver device, the remote data storage system, or both the remote data storage system and the receiver device.

Optionally, the one or more advisory signals communicate a status of the infrastructure to the receiver device. The status can indicate an infrastructure type and location of the infrastructure, a current health of the infrastructure, a predicted health of the infrastructure, a weather condition, an operating condition, and/or a forecasted condition for weather or operation.

Optionally, the one or more advisory signals are generated by equipment at the infrastructure and the one or more advisory signals include an alert of infrastructure failure or a prediction of imminent infrastructure failure. The receiver device can be one of a smart phone or an area alert system that warns people in a determined hazard zone of a status of the infrastructure.

Optionally, the one or more advisory signals are generated by equipment at the infrastructure and include an alert of infrastructure failure or a prediction of imminent infrastructure failure. The receiver device can be configured to communicate with relief equipment that is configured to reduce a risk of the infrastructure failure, and the relief equipment responds by reducing the risk of the infrastructure failure.

Optionally, the one or more advisory signals are generated by first equipment at the infrastructure and include an alert of infrastructure failure or a prediction of imminent infrastructure failure. The receiver device can be configured to communicate with a vehicle or second equipment that is within a hazard zone or moving to or toward the hazard zone. The vehicle or the second equipment can be responsive to the one or more advisory signals by changing an operating mode of the vehicle or the second equipment.

Optionally, the at least one sensor comprises one or more of a piezometer, a tensiometer, an inclinometer, a shape acceleration array, a surveying pin, a Satellite-based Interferometric Synthetic-Aperture Radar (InSar) device, a terrestrial-based radar device, a drone or satellite-collected optic and photogrammetric surveyor, a bathymetric surveyor, a laser scanner, a thermal imager, a Time-Domain Reflectometer (TDR), a flowmeter, a weir with flowmeter, a water level gauge, a seismometer, an array of seismometers, a fiber optic system, and/or an accelerometer.

Optionally, the at least one sensor is configured to generate the sensor data via at least one of a weather station or by field visual inspection.

Optionally, the infrastructure includes at least one of: a dam, a mine, a road, a bridge, a wellbore, an abutment, a retaining wall, a bunding, railroad track, a water distribution system, a pipeline system, a fuel distribution system, a snowbank or permafrost sheet, a port, and/or a dock system.

Optionally, the at least one sensor is configured to be disposed in a drone, disposed in a robotic device, or is carried on a user as a wearable device or a smartphone.

Optionally, the at least one sensor is configured to provide the sensor data as including one or more of a date stamp, a time stamp, a date and time stamp, a location, an acoustic measurement, a temperature measurement, a strain measurement, and/or a vibration measurement.

Optionally, the at least one sensor is configured to provide the sensor data as including one or more of weather data including weather at the infrastructure and weather adjacent to the infrastructure, predictive weather data, seismographic readings, tidal information, vehicle data (including vehicle location, vehicle type, and vehicle loading), photographic data (including time lapse photos and videos), thermographic data, spatial measurements, environmental data (including air humidity and air temperature, snowpack levels, water height and flow rates, ground water levels, and ground saturation levels), infrastructure height relative to ground or to sea level, infrastructure age and condition, and/or foliage type and amount.

Optionally, the remote data storage system is configured to receive the sensor data and determine one or more of whether the sensor data is indicative of a failure of the infrastructure associated with the at least one sensor, whether the sensor data is indicative of a trend toward a future failure of the infrastructure associated with the at least one sensor, whether a combination of the sensor data from a plurality of sensor systems indicates that the infrastructure is failing, whether a natural event occurred that has increased a risk of failure of the infrastructure and when the natural event occurred, whether there is a combination of the sensor data that indicates the risk of failure has increased, which personnel is to receive an advisory signal of an elevated risk in advance of a failure, determine whether there is a war or political risk that would change a determination of the risk of failure, and/or determine a location of a vehicle traversing the infrastructure associated with the at least one sensor and whether the vehicle is loaded or unloaded based on weight.

Optionally, the receiver device is a wearable device, a stationary device, a warning and alarm system, a back-office computer, a laptop computer, and/or a smart phone.

Optionally, the infrastructure is a tailings dam and the at least one sensor comprises a fiber optic cable that is disposed at least partially within the tailings dam, and the remote data storage system can receive the sensor data from the fiber optic cable and builds a base line of sensor readings from the sensor data. In response to a change in the sensor readings relative to the base line that exceeds a determined threshold value relative to an earlier sensor reading, the remote data storage system can create a cloud advisory signal to send to the receiver device.

In one embodiment, a method (e.g., for monitoring an infrastructure) includes receiving sensor data regarding health of the infrastructure from at least one sensor associated with the infrastructure, generating one or more advisory signals based on the sensor data that is received, and communicating the one or more advisory signals to a receiver device responsive to the sensor data indicating that the health of the infrastructure indicates imminent failure of the infrastructure.

Optionally, the infrastructure is a tailings dam and the at least one sensor comprises a fiber optic cable that is disposed at least partially within the tailings dam. The method also can include generating a base line of sensor readings from the sensor data. The one or more advisory signals can be communicated to the receiver device in response to a change in the sensor readings relative to the base line that exceeds a determined threshold value relative to an earlier sensor reading.

In one embodiment, an infrastructure detection and monitoring system includes a remote data storage system configured to receive and communicate sensor data and signals regarding health of a dam. The remote data storage system is configured to process, store, or both process and store at least a first data portion of the sensor data and to generate one or more advisory signals based at least in part on the first data portion. A fiber optic cable is associated with the dam and is configured to generate the sensor data that is communicated to the remote data storage system. A receiver device is configured to receive the one or more advisory signals. The remote data storage system can be configured to communicate the one or more advisory signals to the receiver device responsive to the sensor data indicating that the health of the dam indicates upcoming failure of the dam. Additionally or alternatively, the receiver device can be configured to generate one or more control signals responsive to the one or more advisory signals or responsive to the sensor data indicating that the heath of the dam indicates upcoming failure of the dam.

Optionally, the receiver device is a wearable device, a stationary device, a warning and alarm system, a back-office computer, a laptop computer, and/or a smart phone.

Reference is made in detail to various embodiments of the inventive subject matter, examples of which are illustrated in the accompanying drawings. The same reference numerals used throughout the drawings may refer to the same or like parts. As disclosed below, multiple versions of a same element may be disclosed. Likewise, with respect to other elements, a singular version may be disclosed. Neither multiple versions disclosed, nor a singular version disclosed shall be considered limiting. Specifically, although multiple versions are disclosed, a singular version may be utilized. Likewise, where a singular version is disclosed, multiple versions may be utilized. The description is illustrative and not restrictive. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Other embodiments may be apparent to one of ordinary skill in the art upon reviewing the above description. The scope of the inventive subject matter should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure. And, as used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a remote data storage system configured to receive and communicate sensor data and signals regarding health of an infrastructure, the remote data storage system further configured to process, store, or both process and store at least a first data portion of the sensor data and to generate one or more advisory signals based at least in part on the first data portion;
at least one sensor associated with the infrastructure and configured to generate the sensor data that is communicated to the remote data storage system; and
a receiver device configured to receive the one or more advisory signals,
wherein at least one of:
the remote data storage system is configured to communicate the one or more advisory signals to the receiver device responsive to the sensor data indicating that the health of the infrastructure indicates imminent failure of the infrastructure; or
the receiver device is configured to generate one or more control signals responsive to the one or more advisory signals or responsive to the sensor data indicating that the heath of the infrastructure indicates imminent failure of the infrastructure.

2. The system of claim 1, further comprising: an edge system disposed proximate to the at least one sensor and configured to process at least a second portion of the sensor data prior to the sensor data being communicated to the remote data storage system, the edge system including a cloud computing device that is closer to one or more of equipment or a vehicle at the infrastructure than one or more other cloud computing devices, the edge system configured to generate at least one of the advisory signals and communicate the at least one of the advisory signals to the receiver device, the remote data storage system, or both the remote data storage system and the receiver device.

3. The system of claim 1, wherein the one or more advisory signals communicate a status of the infrastructure to the receiver device.

4. The system of claim 3, wherein the status indicates one or more of:
an infrastructure type and location of the infrastructure,
a current health of the infrastructure,
a predicted health of the infrastructure,
a weather condition,
an operating condition, or
a forecasted condition for weather or operation.

5. The system of claim 3, wherein the one or more advisory signals are generated by equipment at the infrastructure and the one or more advisory signals include an alert of infrastructure failure or a prediction of imminent infrastructure failure, and the receiver device is one of a smart phone or an area alert system that warns people in a determined hazard zone of a status of the infrastructure.

6. The system of claim 3, wherein the one or more advisory signals are generated by equipment at the infrastructure and include an alert of infrastructure failure or a prediction of imminent infrastructure failure, and the receiver device is configured to communicate with relief equipment that is configured to reduce a risk of the infrastructure failure, and the relief equipment responds by reducing the risk of the infrastructure failure.

7. The system of claim 3, wherein the one or more advisory signals are generated by first equipment at the infrastructure and include an alert of infrastructure failure or a prediction of imminent infrastructure failure, and the receiver device is configured to communicate with a vehicle or second equipment that is within a hazard zone or moving to or toward the hazard zone, and the vehicle or the second equipment is responsive to the one or more advisory signals by changing an operating mode of the vehicle or the second equipment.

8. The system of claim 1, wherein the at least one sensor comprises one or more of a piezometer, a tensiometer, an inclinometer, a shape acceleration array, a surveying pin, a Satellite-based Interferometric Synthetic-Aperture Radar (InSar) device, a terrestrial-based radar device, a drone or satellite-collected optic and photogrammetric surveyor, a bathymetric surveyor, a laser scanner, a thermal imager, a Time-Domain Reflectometer (TDR), a flowmeter, a weir with flowmeter, a water level gauge, a seismometer, an array of seismometers, a fiber optic system, or an accelerometer.

9. The system of claim 1, wherein the at least one sensor is configured to generate the sensor data via at least one of a weather station or by field visual inspection.

10. The system of claim 1, wherein the infrastructure includes at least one of: a dam, a mine, a road, a bridge, a wellbore, an abutment, a retaining wall, a bunding, railroad track, a water distribution system, a pipeline system, a fuel distribution system, a snowbank or permafrost sheet, a port, or a dock system.

11. The system of claim 1, wherein the at least one sensor is configured to be disposed in a drone, disposed in a robotic device, or is carried on a user as a wearable device or a smartphone.

12. The system of claim 1, wherein the at least one sensor is configured to provide the sensor data as including one or more of a date stamp, a time stamp, a date and time stamp, a location, an acoustic measurement, a temperature measurement, a strain measurement, or a vibration measurement.

13. The system of claim 1, wherein the at least one sensor is configured to provide the sensor data as including one or more of:
weather data including weather at the infrastructure and weather adjacent to the infrastructure,
predictive weather data,
seismographic readings,
tidal information,
vehicle data including vehicle location, vehicle type, and vehicle loading,
photographic data including time lapse photos and videos,
thermographic data,
spatial measurements,
environmental data including air humidity and air temperature, snowpack levels,
water height and flow rates, ground water levels, and ground saturation levels,
infrastructure height relative to ground or to sea level,
infrastructure age and condition, or
foliage type and amount.

14. The system of claim 1, wherein the remote data storage system is configured to receive the sensor data and determine one or more of:
whether the sensor data is indicative of a failure of the infrastructure associated with the at least one sensor,
whether the sensor data is indicative of a trend toward a future failure of the infrastructure associated with the at least one sensor,
whether a combination of the sensor data from a plurality of sensor systems indicates that the infrastructure is failing,
whether a natural event occurred that has increased a risk of failure of the infrastructure and when the natural event occurred,
whether there is a combination of the sensor data that indicates the risk of failure has increased,
which personnel is to receive an advisory signal of an elevated risk in advance of a failure,
determine whether there is a war or political risk that would change a determination of the risk of failure, or
determine a location of a vehicle traversing the infrastructure associated with the at least one sensor and whether the vehicle is loaded or unloaded based on weight.

15. The system of claim 1, wherein the receiver device is a wearable device, a stationary device, a warning and alarm system, a back-office computer, a laptop computer, or a smart phone.

16. The system of claim 1, wherein the infrastructure is a tailings dam and the at least one sensor comprises a fiber optic cable that is disposed at least partially within the tailings dam, and the remote data storage system receives the sensor data from the fiber optic cable and builds a base line of sensor readings from the sensor data, and in response to a change in the sensor readings relative to the base line that exceeds a determined threshold value relative to an earlier sensor reading, the remote data storage system creates a cloud advisory signal to send to the receiver device.

17. A method comprising:
receiving sensor data regarding health of an infrastructure from at least one sensor associated with the infrastructure;
generating one or more advisory signals based on the sensor data that is received; and
communicating the one or more advisory signals to a receiver device responsive to the sensor data indicating that the health of the infrastructure indicates imminent failure of the infrastructure.

18. The method of claim 17, wherein the infrastructure is a tailings dam and the at least one sensor comprises a fiber optic cable that is disposed at least partially within the tailings dam, and further comprising:
generating a base line of sensor readings from the sensor data, wherein the one or more advisory signals are communicated to the receiver device in response to a change in the sensor readings relative to the base line that exceeds a determined threshold value relative to an earlier sensor reading.

19. A system comprising:
a remote data storage system configured to receive and communicate sensor data and signals regarding health of a dam, the remote data storage system further configured to process, store, or both process and store at least a first data portion of the sensor data and to generate one or more advisory signals based at least in part on the first data portion;
a fiber optic cable associated with the dam and configured to generate the sensor data that is communicated to the remote data storage system; and
a receiver device configured to receive the one or more advisory signals,
wherein at least one of:
the remote data storage system is configured to communicate the one or more advisory signals to the receiver device responsive to the sensor data indicating that the health of the dam indicates upcoming failure of the dam; or
the receiver device is configured to generate one or more control signals responsive to the one or more advisory signals or responsive to the sensor data indicating that the heath of the dam indicates upcoming failure of the dam.

20. The system of claim 19, wherein the receiver device is a wearable device, a stationary device, a warning and alarm system, a back-office computer, a laptop computer, or a smart phone.
